(19) United States
(12) Patent Application Publication
(10) Pub. No.: US 2004/0028809 A1
(43) Pub. Date: Feb. 12, 2004

(54) Porous layers and method for production thereof by means of spin-coating

(76) Inventors: Thomas W. Bein, Graefelfing (DE); Svetlana Ivanova Mintova, Munich (DE)

Correspondence Address: Ronald R Santucci, Frommer Lawrence & Haug, 745 Fifth Avenue, New York, NY, 10151, US

(21) Appl. No.: 10/399,100

(22) PCT Filed: Oct. 19, 2001
(86) PCT No.: PCT/EP01/12153

(30) Foreign Application Priority Data
Oct. 19, 2000 (DE) 100 52 075.8

(51) Int. Cl. B05D 3/12

(52) U.S. Cl. 427/240

(57) ABSTRACT

The present invention relates to porous layers, to a method for the production thereof and to the use of those layers in micro-electronics, in sensors, in catalytic reactions, in separation methods and in optical layers. The layers according to the invention are produced by application of a suspension of porous particles to a substrate by means of spin-coating.

The present invention relates to porous layers, to a method for the production thereof by means of spin-coating and to the use of those layers in micro-electronics, in sensors, in catalytic reactions, in separation methods and in optical layers.

A number of methods for the production of thin porous layers are known. For example, zeolitic layers can be grown directly on porous or non-porous substrates such as silicon, ceramics and metals from hydrothermal synthesis gels or solutions (T. Bein, Chemistry of Materials; 1996, 8, 1636). When those layers are grown on porous substrates, membranes for separation methods are obtained. WO 97/33684 describes the deposition of nanoscale zeolite layers, which are intended to serve as a seed layer. Subsequently, a second zeolite layer is applied by means of hydrothermal synthesis.

The methods described above are mainly used for the production of defect-free membranes for separation methods. Those methods have the disadvantage, however, that the substrates have to be immersed in the hydrothermal synthesis solution in order to cause the layer to grow. The conditions for growth are characterised typically by a high pH value (for example, 11-14) and an elevated temperature (for example 90-200° C.). Therefore, only a small number of substrates, which are not broken down or attacked under the growth conditions, can be used. The number of suitable combinations of zeolite layer/substrate is, accordingly, greatly restricted. In particular, it is not possible, using such methods, to coat silicon wafers because destruction of the wafers takes place under such aggressive conditions. The same is also true for most plastics substrates. In addition, the growth reaction usually requires from several hours up to a few days. Such a length of time is incompatible with the production lines that operate today.

Coatings comprising mesoporous substances, for example using structure-directing surfactants, have hitherto been produced either by direct synthesis, from precursor solutions, on the substrate or by dip coating using suitable reactive precursor solutions (Huo et al., Chem. Mater., 1994, 6, 1176; Sellinger et al. Nature, 1998, V. 394, 256). Those methods likewise have the disadvantages described hereinbefore.

An important area of use for porous layers is micro-electronics. The porous layers can be used as dielectric layers having low dielectric constants (“low-k” dielectrics). The dielectric constants of those layers are, for example, around 2.8. Development in this area is proceeding in the direction of ever smaller design dimensions. With the introduction of the 0.18-μm dimension, delays in the circuits as a whole are sensitively influenced by delays in the connecting line so that copper conductors and “low-k” dielectric intermediate layers are gaining importance. The use of “low-k” dielectrics reduces not only the conductor-to-conductor capacitance but also crosstalk noise between neighbouring connections. The most recent developments in the field of “low-k” dielectrics such as the use of hydrogen silsesquioxane (HSQ) and bicyclobutene polymers and also deposition by means of CVD (chemical vapour deposition) are described in the literature (Mater. Res. Soc. Symp. Proc., “Low-Dielectric Constant Materials” V, 1999, 565). The materials mentioned above have typical k values of at least 2.5. Organic-inorganic polymer composites such as HSOP (hybrid siloxane-organic polymer) and nanoporous amorphous silica films (nanoglass) have been developed with the objective of reducing the dielectric constants still further (D. Toma, S. Kaushal, D. Fatke, Proc. Electrochem. Soc., 2000, 5, 99-7). However, those materials have low mechanical stability and low stability over time and, furthermore, tend to have integration problems. Many of the materials are, in addition, degraded at temperatures above 250° C.

Mesoporous films for “low-k” applications have been produced by spin-coating a reactive precursor solution having organic templates onto a silicon wafer, followed by relatively long heating, calcination and removal of surface hydroxyl groups by treatment with hexamethyidisilazane (HMDS) (S. Baskaran, J. Liu, K. Domansky, N. Kohler, X. Lie, Ch. Coyle, G. Fryxell, S. Thevuthasan, R. E. Williford, Advanced Materials, 2000,12, 291). According to that document, reactive precursor solutions are applied to the substrates, so that subsequent synthesis steps are necessary in order to obtain porous materials. Although those layers have low k values, they are difficult to use in chip production because they have low mechanical stability and the production process is lengthy.

Porous layers are also used in sensor systems. Typical sensor components are transducers, such as a quartz microbalance (QCM) which is combined with a selective layer. Sensors based on zeolite layers on piezoelectric QCMs or surface-wave transducers are described in U.S. Pat. No. 5,151,110 and in S. Mintova, B. J. Schoeman, V. Valtchev, J. Sterte, S. Mo and T. Bein, Advanced Materials, 1997, 7, 585.

A problem of the invention was to provide a fast, flexible method for the production of porous layers. Using that coating method, it should be possible to apply porous layers to a large number of substrates, especially to wafers. A further problem of the invention was to provide porous layers comprising periodic porous materials, which layers especially are homogeneous. For specific applications such as membranes, the layers should be densely packed and have short diffusion paths within the layer.

Those problems are solved by a method for the production of a porous layer, which method comprises the following steps:

(a) provision of a substrate;

(b) provision of a suspension of periodic porous particles; and

(c) application of the suspension to the substrate by spin-coating.

In attempts to apply periodic porous materials to a substrate by spin-coating, the inventors found that the substrate is only irregularly coated, resulting in the formation of strands and in the surface becoming rough. Such non-homogeneous products cannot be used, especially for “low-k” applications.

It has now been found, surprisingly, that homogeneously coated products can be produced when periodic porous particles having an average particle diameter of less than 1 μm, preferably less than 500 nm, especially at most 200 nm, are used.

The invention relates also to coated substrates produced using that method. The homogeneous coated substrates obtained can be employed in catalysis or in separation methods, or can be used as dielectric layers in micro-electronics or as selective layers in sensors or as optical layers. Such coated substrates could not have been produced by prior methods and have therefore not been known hitherto.

The Figures show the following:

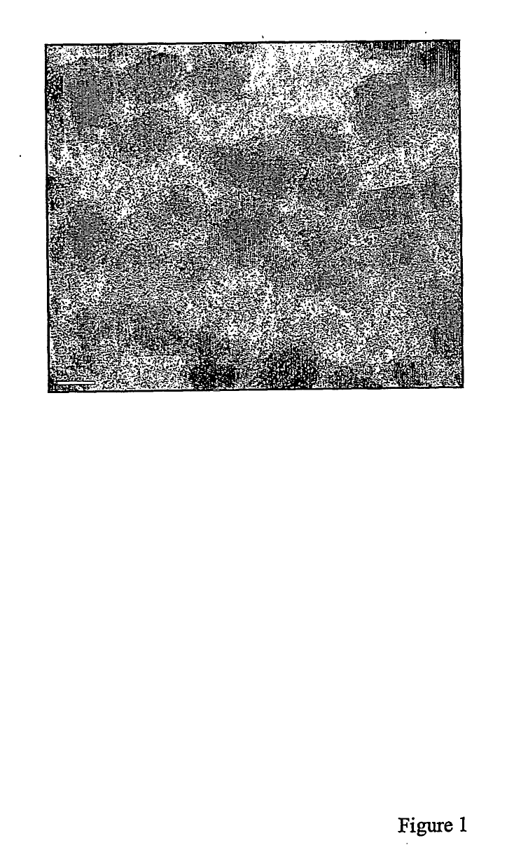

FIG. 1 is a transmission electron microscope picture of the silicalite-1 (MFI) nanocrystals synthesised in Example 1.

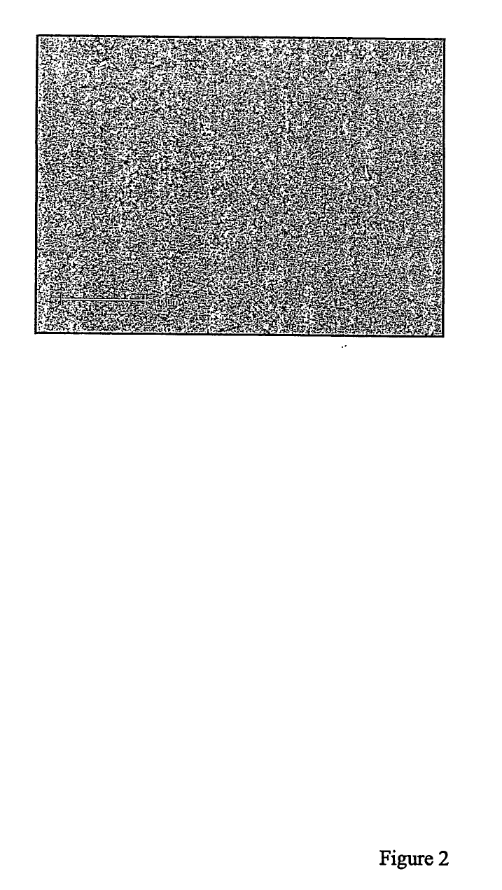

FIG. 2 is a scanning electron microscope picture of a silicalite-1 layer applied to a silicon wafer by means of spin-coating.

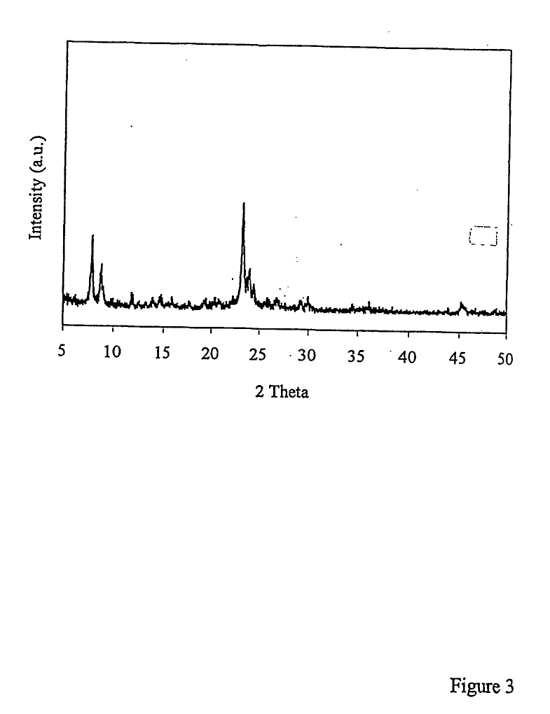

FIG. 3 is an X-ray diffractogram of the silicalite-1 (MFI) nanocrystals synthesised in Example 1.

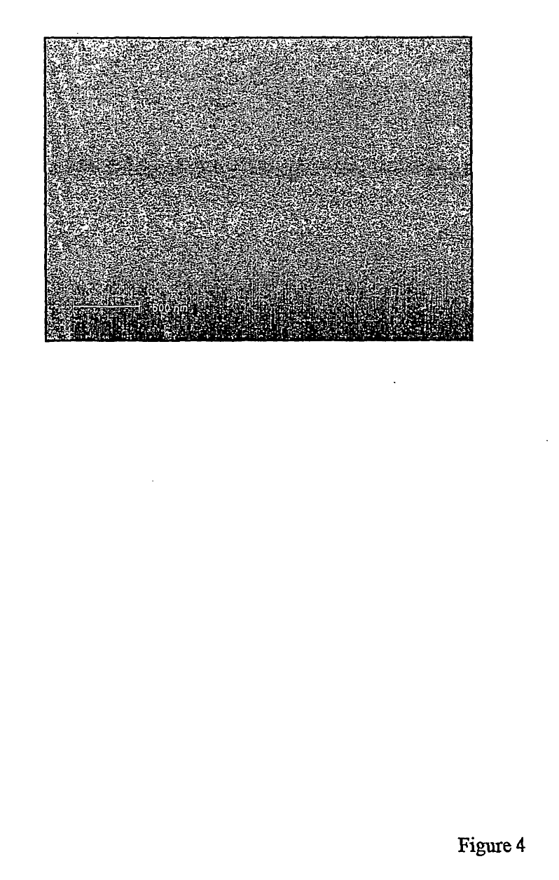

FIG. 4 is a scanning electron microscope picture of a silicalite-1 layer applied to a silicon wafer by means of spin-coating; side view of a break location.

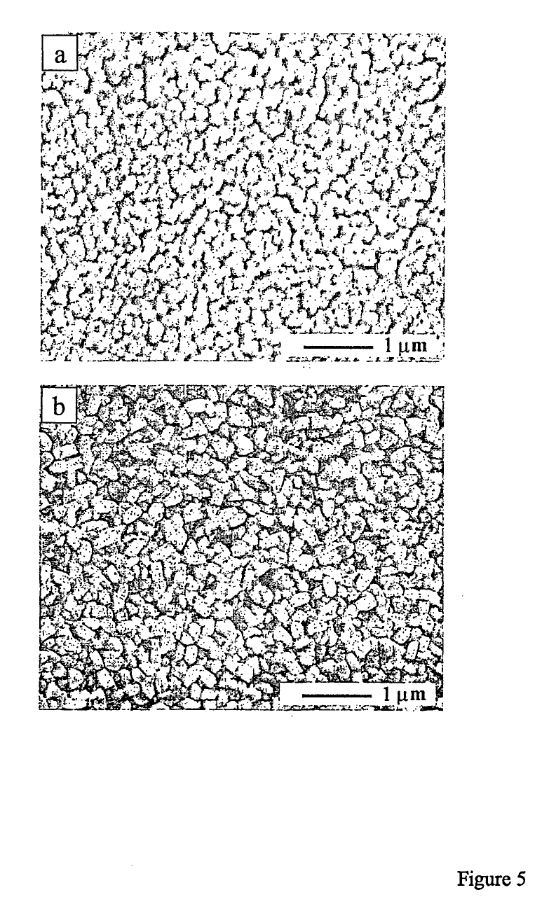

FIG. 5 is a scanning electron microscope picture of a silicalite-1 layer which was obtained on the substrate by means of hydrothermal synthesis.

In the method according to the invention, in contrast to the known methods, the substrates are subjected to only a very small amount of chemical and thermal stress. Consequently, any substrate that can be introduced into a spin-coating apparatus can be coated. Typically, the substrates are planar and may be either porous or non-porous. Selection of the substrate is governed by the intended use of the coated substrate. In general, non-porous substrates are preferred in micro-electronic applications, sensor applications and for optical coatings, whereas the substrate in separation methods and catalytic applications is, typically, porous. Examples of non-porous substrates are metals; semi-metals such as silicon; inorganic oxides such as silica or quartz; glasses and ceramics. Examples of porous substrates are porous inorganic oxide ceramics such as aluminium oxide, silicon oxide, zirconium oxide, titanium oxide and mixtures thereof; porous glasses and porous metals such as sintered porous metals. Besides those inorganic substrates, it is possible to use porous and nonporous polymer substrates and also wood. Preferred substrates are silicon wafers, aluminium oxide, steel and gold.

In many cases it may be desirable to clean the substrate before application of the suspension. The person skilled in the art can select, depending on the substrate, suitable cleaning steps such as rinsing with solvents, acidic or basic solutions, oxidising treatments at high temperature, oxidising treatments in plasma or combinations of those and other treatments.

Depending on the selection of the system comprising the substrate and porous layer, it may be desirable to modify the surface of the substrate in order to increase the adhesion between the substrate and the porous layer. Both physical and also chemical methods come into consideration for modification of the surface. For example, the substrate can be provided with a layer which strengthens the adhesion between the substrate and the porous particles. The person skilled in the art can select a suitable means of surface modification from the known possibilities (Whitesides et al., Crit. Rev. Surf. Chem., 1993, 3, 49; A. R. Bishop and R. G. Nuzzo, Curr. Opin. Colloidal Interface Sci., 1996, 1, 127). For example, the adhesion between gold used as electrode material and a zeolite layer can be improved by adsorbing a monolayer comprising mercaptopropyltrimethoxysilane and then hydrolysing the silane before applying the zeolite layer.

The porous layer is produced by applying a suspension of periodic porous particles to the substrate. In the method according to the invention, preference is given to the use of microporous (average pore size between 0.2 and 2 nm) and mesoporous (average pore size between 2 and 50 nm) periodic materials, although materials having other pore diameters may also be suitable. The pore diameter can be determined by means of gas adsorption and electron microscopy. The porous particles should have an average particle diameter of at least 1 nm and less than 1 μm, preferably at most 200 nm. The size of the particles influences the quality of the coating. Especially smooth, homogeneous coatings are obtained using small particles that have, for example, an average particle diameter of at most 100 nm or at most 50 nm.

Both crystalline and also quasi-crystalline materials can be used as periodic porous materials. Microporous particles that are preferably used are zeolites and also materials of related crystalline lattice structures, pillared-layer minerals such as montmorillonite, microporous particles produced by the sol-gel method, and also microporous carbon. Further preferred microporous particles are aluminium phosphates, silicon aluminium phosphates, metal aluminium phosphates and clathrasils. A series of suitable materials is described in R. Szostak, “Handbook of Molecular Sieves”, Van Nostrand Reinhold, New York, 1992 and in R. Szostak, “Molecular Sieves—Principles of Synthesis and Identification”, Blackie Academic and Professional, London, 2nd Edition, 1998. In the context of the present invention, preference is given to zeolites as microporous materials and periodic meso-structures such as MCM-41, because their properties such as pore size, ion-exchanging capacity and acid functionality can be regulated well, making them attractive as materials for selective adsorption and separation, ion-exchange and catalysis. Depending on their aluminium content, the zeolites may have hydrophobic or hydrophilic properties. Suitable kinds of structure in the context of the present invention are AFI, AEL, BEA, CHA, FAU, FER, KFI, LTA, LTL, MAZ, MOR, MEL, MFI, MTN, MTT, MTW, OFF and TON. MFI or BEA zeolites having an aluminium content of 0 or at most 0.1 or 1% by weight and, especially, MFI zeolites (silicalite-1) are preferred for applications in micro-electronics. In accordance with the invention, it is also possible to use zeolites having a content of metals other than Si, especially of Al. In those applications, especially, the average particle diameter should be at most 100 nm, preferably at most 50 nm.

As periodic mesoporous particles there can be used silicates, aluminium silicates, metal phosphates and other materials that have a regular mesostructure. Suitable periodic mesoporous materials are described, for example, in “Mesoporous Molecular Sieves 1998, Studies in Surface Science and Catalysis”, Vol. 117, Elsevier, Amsterdam, 1998, pages 1-598). The periodic mesoporous particles can be obtained from metal oxide precursors or other related structural precursors and by ionic or non-ionic surfactants. For example, the mesoporous structure can be produced by lyotropic, liquid crystalline structure-directors (for example, alkyl ammonium surfactants, neutral amphiphiles or block copolymers). Preferred mesoporous materials in the context of this invention are MCM-41, MCM-48, SBA-15 and similar compounds having average particle diameters in the range from 50 to 500 nm.

Zeolites (and related materials) are crystalline porous solids that are distinguished by very sharply defined pore openings and channel dimensions in the range between 0.2 and about 2 nm. Furthermore, they have high thermal and chemical stability and a large pore volume, thereby resulting in a wide variety of advantageous properties such as, for example, the selective adsorption of gases and liquids, which allows certain substances to be adsorbed whilst others are kept out from the interior of the crystals (molecular sieve behaviour). Substances can, accordingly, be separated according to their shape and size. By incorporating different elements into the zeolite lattice, they can be controlled, over a wide range, in terms of their affinity with respect to molecules to be adsorbed; accordingly, zeolites may exhibit both hydrophilic and also hydrophobic behaviour—the adsorption properties may also be controlled by that means. Those properties result in, for example, possibilities for use in membranes for separation methods and selective adsorption layers for sensors. Because of their possibly highly hydrophilic nature, zeolites may be used beneficially in dehumidifying films in optical windows.

Compared to amorphous silicon dioxide, zeolites have enormous mechanical and thermal stability; many zeolites such as silicalite can be heated to above 1100 degrees Celsius whereas the amorphous oxide already starts to lose its porosity, because of softening, at more than about 500 degrees. Also, the chemical stability of high-silicon-content zeolites is often far greater than that of the amorphous oxides—the latter, after all, being used as starting materials for zeolite synthesis.

It is furthermore possible to introduce charge into the lattice by incorporating lattice components of different valency (for example, aluminium in silicate); this then makes possible the problem-free exchange of ions from liquids. The ion-exchanging behaviour of zeolites is characterised by very high exchange capacity and selectivity. In addition, it is also possible to introduce acid groups of very strong acidity, resulting in high catalytic activity. With amorphous materials, such high acidic strengths are very difficult to accomplish or cannot be accomplished at all.

Ion-exchange can be used, for example, for introducing metal ions such as, for example, Pt, which then occupy defined extra-lattice locations and, for example, can be reduced in controlled manner so that very fine metal clusters in the nanometre range are formed. These are stabilised by the zeolite lattice and can serve as highly active catalysts. Further synthesis steps such as, for example, oxidation before or after film formation can follow, in order to stabilise highly dispersed metal oxide clusters in the zeolite. Amorphous silicon dioxide has neither ion-exchange capacity nor well-defined cages with coordination locations so that, when metal clusters are introduced (by impregnation), only wide particle size distributions of low surface area are obtained.

Further possible modifications to the zeolites are, for example, the introduction of molecular guests such as, for example, phthalocyanine complexes or receptors that can serve as selective catalysts or as sensor molecules. In amorphous porous materials such as silicon dioxide, there are no well-defined cages available for selectively including such guests, nor any molecular sieve properties.

The periodic mesoporous materials are distinguished by extremely high pore volumes and surface areas (of up to more than 1000 m²/g). As a result of the geometrically regular—periodic—arrangement of the pores (for example, in parallel, hexagonally packed bundles), extremely fast diffusion of guests and, as a result, transport of reactants in catalytic reactions, equilibrium establishment in adsorption processes, or rapid response behaviour of sensor layers are achieved. In contrast thereto, amorphous porous substances such as silicon dioxide usually have highly convoluted or even closed pores so that transport is made difficult.

The well-defined pore structure of the periodic mesoporous materials having pore diameters between about 1.5 and 30 nm also makes it possible to utilise molecular sieve behaviour for relatively large molecules such as, for example, enzymes. It is furthermore possible, by means of co-condensation of reactive groups with the aid of suitable silane coupling reagents, to specifically functionalise the internal surface of the mesoporous materials; the synthesis mechanism with surfactant molecules allows the arrangement and orientation of the reactive groups in the open pore volume to be controlled in advantageous manner. Such functional groups can be used, for example, in catalysis or in selective sensor systems; in the latter case, receptor molecules, for example, are incorporated which allow selective interaction with, and detection of, analytes. Reading mechanisms can be accomplished, for example, piezoelectrically (mass), optically (solvatochromism or specific spectral changes) or calorimetrically (heat generation with selective catalysts); that is also true for zeolites.

In general, the spin-coating method provides the possibility of layering entirely different (or identical) films on top of another in independent steps, in any desired sequence, in order to obtain the desired properties such as thickness or functionality. That possibility is ruled out in the case of direct synthesis because the subsequent synthesis will in turn attack, dissolve or, at least, modify the films previously deposited. Moreover, the films obtained in spin-coating are distinguished by very high uniformity of thickness and morphology over the dimensions of the substrate. In the case of direct synthesis, that cannot be achieved because even minimal convection in the solution, temperature differences, or sedimentation of precursor species in the solution will result in marked variations in the morphology and thickness of the films.

If desired, the porous particles can be pre-treated in accordance with known methods, in order to obtain specific properties. Examples thereof are ion-exchange with other metal ions, reduction at elevated temperature, intraporous synthesis of guest species such as catalytically active metal complexes, or modifications to the lattice by means of treatment with volatile metal precursors such as silicon tetrachloride (T. Bein, Solid-State Supermolecular Chemistry: Two- and Three-dimensional Inorganic Networks, Comprehensive Supermolecular Chemistry, Vol. 7 (Editors: G. Alberti, T. Bein), Elsevier, Tarrytown, N.Y., 1996, 465).

If desired, mixtures of porous particles having disparate particle sizes, disparate pore sizes, disparate crystalline forms and/or chemical compositions may be used.

The porous particles are suspended in a suitable solvent. Suitable solvents include both organic and inorganic solvents. The solvent should not attack the substrate or impair the spin-coating method. Furthermore, it should be possible for the solvent to be readily separated off, for example by evaporation, after the spin-coating step. In order to ensure uniform coating, the suspension of porous particles should be stable, that is to say the particles should not settle out before application of the suspension. That can be ensured by selection of a suitable solvent and/or dispersant. Examples of suitable solvents are acetone, C₁₋₄alkanols and water. Preference is given to the use of ethanol or acetone.

The suspension can be produced by simply dispersing the particles in the solvent. It is also possible, however, to produce the suspension by treating in an ultrasonic bath and/or by adding surfactants or other dispersants.

In general, the porous particles should have a regular or irregular, approximately spherical shape. However, in some cases it may be desirable to use needle-shaped or disc-shaped porous particles. On spin-coating, those needles or discs orientate themselves parallel to the substrate and, in addition, may, for example in the case of magnetic particles, be orientated by application of a magnetic field.

A further advantage of the present invention is that additional particulate materials may be introduced into the porous layer in addition to the porous particles. Such additional particulate materials may regulate the catalytic activity, the redox properties, the magnetic properties or the optical properties of the porous layer. Examples thereof are particulate materials of metal, metal oxides and also composites of metal and metal oxide. Suitable metal oxides include, for example, colloidal silicon dioxide, colloidal aluminium oxide, colloidal titanium oxide and other particulate metal oxides. The metal oxides can be obtained by precipitation methods or the sol-gel method. In the method according to the invention, the porous particles can be mixed with the additional particulate materials in any ratio. The weight ratio of the porous particles to the additional particulate materials is highly dependent upon the system desired. The weight ratio of the porous particles to the additional particulate materials is preferably from 0.01:0.99 to 0.99:0.01, especially from 0.50:0.50 to 0.99:0.01. The size of the additional particulate materials should be in the range indicated for the porous particles.

The suspension of periodic porous particles is applied to the substrate by spin-coating. In the spin-coating method, a small amount of the suspension is applied to the centre of the substrate to be coated. The substrate is then caused to rotate rapidly, whereupon a thin film of the suspension spreads out over the substrate and the solvent evaporates off.

In a preferred embodiment, the substrate is rotated in a spin-coating apparatus at a speed of rotation of from 100 rpm to 10,000 rpm, preferably from 1000 rpm to 3500 rpm, and at an acceleration rate of from 100 rpm/s to 5000 rpm/s, preferably from 1000 rpm/s to 3000 rpm/s. Typically, from 0.2 ml to 10 ml, preferably from 0.5 ml to 2 ml, of the suspension of porous particles is applied to the centre of the substrate. The amount is dependent on the size of the substrate and the desired layer thickness. The suspension should have a solids content of from 0.5% by weight to 30% by weight, preferably from 2% by weight to 10% by weight. As a result of rotation of the substrate, the suspension becomes evenly distributed over the surface of the substrate. This procedure usually lasts between 5 and 120 seconds, preferably between 10 and 60 seconds. The thickness of the layer can be influenced by the concentration of solids in the suspension and also by the speed of rotation and/or the amount applied. Using the spin-coating method according to the invention, layer thicknesses of between 30 nm and 1000 nm are typically obtained in one spin-coating step. By repeating the spin-coating several times, thicker layers can be obtained. It is also possible to apply different suspensions, one after the other, by spin-coating and so to produce multiple layers. If desired, using known methods, the porous layers can also be applied to the substrate in the form of patterns (Fan et al., Nature, 2000, V. 405, 56; Kind et al., Adv. Mater, 1999, 11, 15). Areas that are not to be coated can be masked by means of wax or in the manner carried out in the case of photoresist films. After application and, where appropriate, stabilisation of the porous layer, the masking is removed again.

Furthermore, the substrate may be so pre-treated that it adsorbs the porous particles. Such pre-treatment may include rinsing with suitable solvents, acidic or basic rinsings, oxidising treatments at high temperatures or in plasma, or suitable combinations.

Although the porous layers have good properties after removal of the solvent, it may, in some cases, be desirable for the mechanical stability of the porous layer to be increased further. For that purpose, a binder may be added to the suspension of porous particles. It is also possible to apply an additional layer of binder, for example by spin-coating, on top of the porous layer already applied. The binder can also be used in the form of a precursor thereof. In accordance with the invention, preference is given to the use of a binder, with special preference being given to adding the binder to the suspension before the latter is applied to the substrate.

Selection of the binder is governed by the system comprising the porous particles and substrate. The binder may be any desired substance that increases the mechanical stability of the layers compared to identical layers without binder. Examples of suitable binders or binder precursors include metal oxide precursors, polymers and polymerisable compounds. Selection of the binder is preferably carried out in close coordination with the desired end use of the coated substrate. Suitable polymers include, for example, silicones. As polymerisable compound, hydrogen silsesquioxane, for example, is suitable. If the polymerisable compounds are liquids, it is possible for the porous particles to be suspended therein directly and to dispense with a further solvent.

For applications such as, for example, in the area of “low-k” dielectrics, the binder can be selected, for example, from metal oxide precursors that are obtained in the sol-gel process. Prehydrolysed or non-prehydrolysed tetraethyl orthosilicate (TEOS) is especially suitable.

If it is intended to obtain especially stable porous layers, it may be desirable to produce a chemical bond between the porous particles and the optionally present particulate materials and the substrate. That can be achieved by reacting functional groups that are present on the surfaces of the particles in question and on the surface of the substrate and in the binder. Suitable reactive binder systems will be known to the person skilled in the art. There may accordingly be used, for example in the case of metal-oxide-containing porous particles, silane coupling reagents such as 3-amino(propyltrimethoxysilane). When selecting the binder, however, it should be ensured, where appropriate, that it does not excessively diminish the porosity of the layer and that, as a result, diffusion in the resulting porous layer is not excessively reduced. The selected binder also should not adversely affect the other properties that are of importance for the desired end use, such as catalytic activity in the case of catalytic uses or refractive index in the case of optical uses. When the binder is added to the suspension, the weight ratio of binder:particles should be preferably at most 1:1, more preferably at most 1:5, even more preferably at most 1:10, and most preferably about 1:20.

Depending on the binder selected, it may be necessary to subject the binder to after-treatment. That after-treatment may be a simple baking process wherein not only is the solvent evaporated off but also the binder is stabilised, or the after-treatment may include a polymerisation reaction. In the case of a baking process, the temperature is dependent upon the binder system selected, the porous particles and the substrate. The temperatures may be between 40 and 1200° C., preferably between 100 and 800° C. and more preferably between 250 and 800° C. for inorganic systems or for systems in which decomposition of the the binder is intended. Organic binders typically require lower temperatures. In the case of polymerisable binders, the polymerisation may be carried out photochemically, thermally or chemically (for example by means of treatment with aqueous, acidic or basic vapours).

The present invention provides a fast, efficient method for the preparation of porous layers from periodic materials. In contrast to the methods used hitherto, wherein the substrate is immersed in a hydrothermal solution, the spin-coating method according to the invention avoids subjecting the substrate to thermal and chemical stress. Accordingly, a large number of substrates that could not be used in the methods known hitherto can be coated with thin, porous layers. The porous layers obtained exhibit high quality (uniform coating) and, especially, mechanical stability, for example with respect to ultrasound and solvents.

The substrates having porous layers in accordance with the invention can be used as dielectric layers in micro-electronics, as selective layers in sensors, or in catalysts. In addition, they are used in separation methods and as optical layers.

In optical applications, the substrates having a porous layer comprising periodic materials, in accordance with the invention, are suitable, for example, as an anti-reflection layer, as chemically reactive layers on optical surfaces, or as dehumidifying layers in optical windows. In many cases, the sensitive nature of the optical surfaces to be coated has prevented zeolite layers from being grown directly on the optical material. In addition, the large crystallite dimensions that are obtained by the known methods resulted in scattering of the light. They were, therefore, not suitable for the production of crystalline, porous, optical layers. The spin-coating method according to the invention avoids subjecting the substrates to hydrothermal stress and can reduce scattering in the layers because the crystallite sizes can be freely selected over wide ranges in the case of spin-coating. In addition, by means of optional multiple coating, it is possible to produce relatively thick films which consist of very small crystals.

The method according to the invention is also especially suitable for the production of “low-k” dielectric layers. The coated substrates obtained have improved chemical and mechanical stability and, in addition, may be produced simply and rapidly.

The porous layers may be used in a large number of sensors, especially in the selective layer. The possible areas of use include piezoelectric mass detection, calorimetric detection and optical detection.

Special preference is given to the provision, in accordance with the invention, of silicon wafers that have at least one layer of at least one periodic, porous, especially crystalline porous (e.g. zeolitic) or periodic mesoporous material.

The periodic porous materials preferably have an average particle diameter of at most 200 nm and can be applied in a plurality of identical or different layers; for example, the number of layers may be 1, 2, 3 or 4. For low-k applications, the porous layers have k values of preferably less than 3, more preferably less than 2.5, and especially less than 2. Minimal k values of 1.5 can also be achieved.

In accordance with the invention, the porous layer can be produced by mounting, on a rotatable carrier, a plurality of substrates according to the invention, preferably in a crown-shaped arrangement and especially with the length in the direction of the centre-line of the carrier, then applying a suspension according to the invention in the region of the intersection point of the axis of rotation, and rotating the carrier to such a degree that the applied suspension becomes distributed over the individual substrates as a consequence of centrifugal force.

For that purpose, there may be used, for example, an apparatus that has a rotatable carrier which is suitable for accommodating a plurality of substrates in a preferably crown-shaped arrangement around the axis of rotation, an application device for the application of a suspension according to the invention in the region of the intersection point of the axis of rotation through the carrier, and also a drive which is suitable for causing the carrier to rotate at such a speed that the suspension becomes distributed over the substrates, which are preferably mounted in a crown-shaped arrangement.

The present invention will be illustrated with reference to the Examples that follow, without, however, being limited to the embodiments described therein.

### EXAMPLES

Characterisation of the Porous Coatings

The coated substrates produced were characterised by means of X-ray diffraction and a scanning electron microscope.

Apparatus used:

X-ray diffraction: XDS 2000, from Scintag, in θ-θ mode, 5-50 degrees 2θ, slits 0.1; 0.2; 0.3; 0.5 mm; 30 min. measuring time.

Electron microscope: Philips XL30; gold-coated samples.

### Example 1

This Example illustrates the production of 250-nm thick silicalite-1 layers on silicon wafers by direct coating by means of spin-coating.

Preparation of the Silicalite-1 Crystals:

Tetraethyl orthosilicate (TEOS) 98%, tetrapropylammonium hydroxide and double-distilled water were mixed in the molar ratio 25.0:9.0:408. The suspension was prehydrolysed in an automatic shaker for 24 hours. Subsequently, hydrothermal treatment was carried out at 90° C. for 48 hours. The crystals were separated off from the mother solution by centrifuging three times (20,000 rpm; 30 minutes), the crystal cake being re-dispersed each time in 2 ml of double-distilled water in an ultrasonic bath (Branson 200, room temperature, one hour). The pH of the suspension after purification was 9.8. An electron microscope picture of the resulting nanocrystals is shown in FIG. 1. The average particle diameter is about 50 nm.

1.4 g of the freshly centrifuged silicalite-1 crystals were taken up in 20 ml of ethanol and 20 ml of tetraethyl orthosilicate and dispersed in the ultrasonic bath for 2 hours. 1.3 ml of a mixture of 10 ml of double-distilled water and 0.49 ml of 37% hydrochloric acid were added to the resulting homogeneous suspension. The resulting suspension had a solids content of 3.5%. It was hydrolysed for 24 hours in an orbital shaker (VWR Scientific Products, Orbital Shaker, 150 rpm) before it was used for production of the porous coatings.

The porous coatings were applied to a silicon wafer in a coating step by means of spin-coating (RC8 Gyrset, Spin-Coater, Karl Süss). The silicon wafers being coated were held on the carrier during the spin-coating step by means of a vacuum.

The silicon wafers were first cleaned for 10 seconds using about 20 ml each of ethanol and acetone. Before and after the cleaning step, the wafers were blown with nitrogen in order to remove dust and to dry the wafers. 0.1, 0.2 or 0.4 ml of the silicalite-1 suspension was applied to the middle of the 3-, 4- or 8-inch silicon wafers, respectively. At an acceleration rate of 1000 rpm/s and a speed of rotation of 3000 rpm, coatings having a layer thickness of about 250 nm (after drying) were obtained within a period of 35 seconds. The substrates were heated at 420° C. in air for one hour in order to remove the tetrapropylammonium hydroxide from the zeolitic cavities and in order to stabilise the layer.

FIG. 2 shows a scanning electron microscope picture of the silicalite-1 coating on the silicon wafer. The layer thickness was estimated from a side view of this picture. It was confirmed by X-ray diffraction that the coating consists of silicalite-1 (reflections at 7.95 and 23.19° 2 theta).

### Example 2

This Example describes the preparation of silicalite-1 coatings having a thickness of 200 and 400 nm on silicon wafers, by means of spin-coating.

A suspension of discrete silicalite-1 crystals was obtained by the method described in Example 1. In the process there was first used a reaction mixture having the following molar composition: 9 tetrapropylammonium hydroxide: 25 silicon dioxide: 1450 double-distilled water: 100 ethanol (from TEOS). After a reaction time of 18 hours, the crystal cake obtained was separated off from the mother liquor by centrifuging, after which the particles were taken up in ethanol. The resulting suspension contained 6.5%, by weight, silicalite-1. The crystal size was determined by means of dynamic light scattering and high-resolution electron microscopy and was about 90 nm.

2 ml of the resulting suspension were applied to 3- and 4-inch silicon wafers. The wafers were, in both cases, coated for 60 seconds at an acceleration of 1500 rpm/s and a speed of rotation of 3500 rpm. The wafers were subjected to after-treatment at 420° C. in air for 20 minutes. The porous coating obtained had a thickness of about 400 nm.

When acetone/silicalite-1 solutions are used in the same manner as the above ethanol/silicalite-1 solutions (3% by weight), a film thickness of 200 mm is obtained.

### Example 3

This Example describes the production of strongly adhering silicalite-1 layers by the separate application of a zeolite/ethanol suspension and a prehydrolysed tetraethyl orthosilicate solution.

As in Example 1, a reaction mixture having the molar composition: 3 tetrapropylammonium hydroxide: 25 silicon dioxide: 1500 double-distilled water: 100 ethanol (from TEOS) was prepared. This composition was hydrothermally treated after 24 hours' prehydrolysis at 100° C. for 48 hours in polyethylene bottles. The particles were cleaned by centrifuging (20,000 rpm, 20 minutes) twice and redispersing in 25 ml of distilled water in order to remove unreacted organic material. After the final centrifugation, the particles were taken up in 98% ethanol to obtain a 5.5% solution by weight. It was shown, by means of X-ray diffractometry, that a pure silicalite-1 phase without amorphous impurity is present (FIG. 3).

A binder composition of 30 ml of ethanol, 30 ml of 98% tetraethyl orthosilicate and 0.4 ml of water containing 0.1 ml of 37% hydrochloric acid was prepared and, before use, treated for 24 hours in an orbital shaker. As in Example 1, 3-inch silicon wafers were first cleaned and then coated with 2 ml of the ethanol/zeolite solution. The acceleration was 1500 rpm/s and the speed of rotation was 3500 rpm. The coating lasted 40 seconds. Evenly coated wafers were obtained with a high degree of reproducibility. After application of the zeolite coating, 1 ml of the binder composition was applied at an acceleration of 1000 rpm/s and a speed of rotation of 1000 rpm within a period of 40 seconds. This resulted in complete coverage of the zeolite layer with prehydrolysed tetraethyl orthosilicate. This was followed by calcination at 420° C. in air for one hour.

By means of this two-step coating method, strongly adhering porous coatings were obtained on the silicon wafer. These layers are able to withstand treatment in an ultrasonic bath for several hours and are not attacked by acetone or ethanol.

### Example 4

This Example describes the production of a two-layer silicalite-1 layer having a total layer thickness of 400 nm by successive application of zeolite suspensions.

Using the silicalite-1 suspension obtained in Example 1, a first silicalite-1 layer was applied to a cleaned silicon wafer. For that purpose, 2 ml of the suspension were applied at an acceleration of 1500 rpm/s and a speed of rotation of 3000 rpm for 30 seconds. A second layer was applied under identical conditions. This was followed by calcination at 420° C. in air for one hour.

The porous layer obtained was studied using an electron microscope. Two discernibly different layers can be seen on the pictures. The total layer thickness is about 400 nm (FIG. 4).

### Comparison Example

A polymer layer is produced on a silicon wafer by immersing the wafer for 20 minutes at room temperature in an aqueous solution containing 0.5%, by weight, of cationic polymer (Berocell 6100, molecular weight about 50000, Akzo Nobel). Colloidal silicalite-1 crystals are then adsorbed onto the modified silicon wafer by immersing the substrate for one hour in a purified colloidal solution containing 3%, by weight, of silicalite-1 in water. A thicker, mechanically stable silicalite-1 layer is then produced on the modified substrate by keeping it in a hydrothermal synthesis solution of composition 3 TPAOH: 25 SiO₂: 1500 H₂O: 100 EtOH for (a) six hours and (b) 30 hours at 100° C. (See FIGS. 5(a) and (b).)

1. Method for the production of a porous layer, comprising the steps:
(a) provision of a substrate;
(b) provision of a suspension of periodic porous particles; and
(c) application of the suspension to the substrate by spin-coating.

2. Method according to claim 1, wherein the substrate is a silicon wafer, metal, silicon, silica, glass, quartz glass, plastics, dense ceramic, alumina, zirconia, titania, or a mixture thereof, porous glass, sintered porous metal or wood.

3. Method according to one of the previous claims, wherein the porous particles have an average particle diameter of at most 200 nm.

4. Method according to one of the previous claims, wherein the porous particles have a pore diameter in the range from 0.2 nm to 2 nm or from 2 nm to 50 nm.

5. Method according to one of the previous claims, wherein the porous particles comprise zeolites or materials of related crystalline lattice structures or mixtures thereof.

6. Method according to one of the previous claims, wherein the porous particles comprise periodic mesoporous materials.

7. Method according to one of the previous claims, wherein the porous layer has a layer thickness in the range from 30 to 1000 nm.

8. Method according to one of the previous claims, wherein the suspension furthermore comprises at least one binder or binder precursor.

9. Method according to one of the previous claims, wherein the method furthermore comprises the step:
(d) application of a binder layer to the porous layer.

10. Method according to claim 8 or 9, wherein the binder is subjected to after-treatment in order to increase the stability of the porous layer.

11. Method according to one of the previous claims, wherein the suspension for the spin-coating step comprises the particulate porous material and one or more additional particulate materials.

12. Method according to one of the previous claims, wherein the same application steps are repeated on the same side of the substrate once or more than once.

13. Method according to one of the previous claims, wherein one or more different application steps are successively applied to the same side of the substrate.

14. Method according to one of the previous claims, wherein the substrate is partially covered before application of the suspension, and the covering is removed after application of the suspension.

15. Method according to one of the previous claims, wherein the covering is a mask of wax or a photoresist.

16. Substrate having one or more porous layers, obtainable by a method according to one of the previous claims.

17. Use of the coated substrate according to claim 16 in micro-electronics, in sensors, in catalytic reactions, in separation methods or in optical layers.

18. Use of the coated substrate according to claim 16 as a substrate having a dielectric layer of a low dielectric constant.

19. Use according to claim 17, wherein the porous layer comprises the zeolite MFI having a very high silicon content (silicalite-1) or another zeolite having a high silicon content.
